(19) United States
(12) Patent Application Publication
(10) Pub. No.: US 2016/0157127 A1
(43) Pub. Date: Jun. 2, 2016

(54) Method and Apparatus for Packet Capture Using Preambles and Postambles

(71) Applicants: Linda M. Zeger, Lexington, MA (US); Muriel Medard, Belmont, MA (US); Amanda Randles, Cambrige, MA (US)

(72) Inventors: Linda M. Zeger, Lexington, MA (US); Muriel Medard, Belmont, MA (US); Amanda Randles, Cambrige, MA (US)

(73) Assignee: MASSACHUSETTS INSTITUTE OF TECHNOLOGY, Cambridge, MA (US)

(21) Appl. No.: 13/890,604

(22) Filed: May 9, 2013

Related U.S. Application Data
(60) Provisional application No. 61/644,671, filed on May 9, 2012.

(51) Int. Cl. H04W 28/04; H04L 12/26

(52) U.S. Cl. CPC H04W 28/044; H04L 43/16

(57) ABSTRACT

In a transmitting device, packets are generated that include both preambles and postambles under some network conditions and packets are generated that include only a preamble or a postamble under other network conditions. Both the preamble and the postamble of the packets may include information that can be used by a receiver device in receipt of a packet to determine that a packet has arrived. The information within the preamble and the postamble may also, in some cases, be used to aid in decoding the packet. In some implementations, preambles and postambles are used that follow a format similar to the long and/or short preambles specified in the IEEE 802.11 wireless networking standard.

### CROSS REFERENCE TO RELATED APPLICATION

The present application claims the benefit of U.S. Provisional Patent Application No. 61/644,671 filed on May 9, 2012, which is incorporated by reference herein in its entirety.

### STATEMENT REGARDING FEDERALLY SPONSORED RESEARCH

The invention disclosed herein was made with government support under Contract No. FA8721-05-C-0002, awarded by the U.S. Air Force. The government has certain rights in this invention.

### BACKGROUND

The problem of packet capture in systems with packet collisions has been extensively considered. The problem of wireless interference when packets overlap at a receiver (such events are generally termed collisions) has been addressed in several ways. The main approach has consisted of attempting to avoid collisions through reservations of the shared medium, either in real time or through some pre-arranged scheme such as time-division or frequency-division multiplexing. In such models, collided packets are deemed to be unusable. The strictures imposed by attempting to avoid collisions or disallowing them altogether can severely diminish system performance in wireless networks or require very onerous coordination. Moreover, in some cases, systems may be unable to maintain separation of packets at receivers (e.g., the hidden node problem).

### SUMMARY

Techniques, devices, and systems are described herein that can improve the likelihood of packet capture in a wireless receiver when packets collisions occur. This may be achieved by, for example, generating, transmitting, and/or receiving wireless signals that have both preambles and postambles. In some embodiments, packets may be generated for transmission that include both preambles and postambles under some network conditions and packets may be generated for transmission that include only a preamble or a postamble under other network conditions. For example, in one implementation, packets are generated that have both a preamble and a postamble when a network traffic level is above a predetermined threshold and packets are generated having just a preamble when the network traffic level is below the predetermined threshold. When both a preamble and a postamble are present in a packet, both the preamble and the postamble may include information that can be used by a receiver node in receipt of the packet to determine that a packet has arrived (i.e., to capture the packet, etc.). In some implementations, SYNC fields may be used in both a preamble and a postamble of a signal that are the same as or similar to those of the PLCP preamble specified in the IEEE 802.11 wireless networking standard. Other types of information may additionally or alternatively be included within the preambles and postambles of signals in other implementations. Among other benefits, a postamble within a signal may allow a receiver to recognize that a packet has arrived even when a preamble of the signal has been corrupted in the channel by collision and/or one or more other forms of interference or noise.

In accordance with one aspect of the concepts, systems, circuits, and techniques described herein, an apparatus comprises means for obtaining information about a network parameter, and a packet generator to generate a packet for transmission to a remote node, the packet generator to generate a packet having both a preamble and a postamble if the network parameter meets a predetermined criterion and a packet having only a preamble or a postamble if the network parameter does not meet the predetermined criterion.

In one embodiment, the network parameter is a network traffic level and the predetermined criterion is the network traffic level exceeding a threshold level.

In one embodiment, the preamble and the postamble of the packet generated by the packet generator if the network parameter meets the predetermined criterion both include information for use by a receiver in receipt of the packet to identify that a packet has arrived.

In one embodiment, the postamble of the packet generated by the packet generator if the network parameter meets the predetermined criterion includes some information that the preamble does not include.

In one embodiment, the preamble of the packet generated by the packet generator if the network parameter meets the predetermined criterion includes some information that the postamble does not include.

In one embodiment, the postamble of the packet generated by the packet generator if the network parameter meets the predetermined criterion includes a field for at least one of packet length and packet data rate and the preamble of the packet does not.

In one embodiment, the postamble of the packet generated by the packet generator if the network parameter meets the predetermined criterion includes a field for user data and the preamble of the packet does not.

In one embodiment, the preamble and the postamble of the packet generated by the packet generator if the network parameter meets the predetermined criterion are identical.

In one embodiment, the preamble and the postamble of the packet generated by the packet generator if the network parameter meets the predetermined criterion both include a SYNC field with a SYNC sequence for use by the remote node to synchronize with the packet upon reception.

In one embodiment, the SYNC sequence in the preamble of the packet is different from the SYNC sequence in the postamble of the packet.

In one embodiment, the SYNC sequence in both the preamble and the postamble of the packet are in accordance with those specified in the IEEE 802.11 family of wireless networking standards for use in a packet preamble.

In one embodiment, the apparatus includes a wireless node device for use in a wireless network.

In one embodiment, the apparatus includes a cellular telephone.

In one embodiment, the apparatus includes an integrated circuit.

In accordance with another aspect of the concepts, systems, circuits, and techniques described herein, a method comprises: determining whether one or more conditions exist in a network; and generating a packet for transmission to a remote node in the network, wherein generating a packet includes generating a packet having both a preamble and a postamble if a predetermined condition exists in the network and generating a packet having only a preamble or a postamble if the predetermined condition does not exist in the network.

In one embodiment, generating a packet having both a preamble and a postamble includes generating a packet wherein the postamble includes some information that the preamble does not.

In one embodiment, generating a packet having both a preamble and a postamble includes generating a packet wherein the preamble includes some information that the postamble does not.

In one embodiment, generating a packet having both a preamble and a postamble includes generating a packet wherein the postamble includes a field for at least one of packet length and data rate of the packet and the preamble does not.

In one embodiment, generating a packet having both a preamble and a postamble includes generating a packet wherein the postamble includes a field for user data and the preamble portion does not.

In one embodiment, generating a packet having both a preamble and a postamble includes generating a packet wherein the preamble and the postamble are identical.

In one embodiment, generating a packet having both a preamble and a postamble includes generating a packet wherein both the preamble and the postamble of the packet include information intended for use by a receiver device in receipt of the packet to identify a beginning and an end of the packet.

In one embodiment, generating a packet includes generating a packet having both a preamble and a postamble if an estimated network traffic level is within a first range and transmitting a packet having a preamble portion but no postamble portion if the estimated network traffic level is not within the first range.

In one embodiment, generating a packet having both a preamble and a postamble includes generating a packet wherein the preamble and the postamble each include a SYNC field with a SYNC sequence for use by a receiver device to synchronize with the packet, wherein the SYNC sequence in the preamble is different from the SYNC sequence in the postamble.

In one embodiment, the method further comprises: transmitting a first packet having both a preamble and a postamble to the remote node, the first packet colliding with a second packet transmitted by another node; and performing zig-zag decoding at the remote node to recover data within both the first packet and the second packet, wherein performing zig-zag decoding includes using a postamble associated with either the first packet or the second packet to determine a starting point of the packet. In one embodiment, performing zig-zag decoding includes performing zig-zag decoding in both a forward direction and a reverse direction, wherein performing zig-zag decoding in a reverse direction includes using a postamble associated with either the first packet or the second packet.

In one embodiment, the method further comprises: transmitting a first packet having both a preamble and a postamble to the remote node, the first packet colliding with at least one other packet transmitted by at least one other node; and estimating, at the remote node, a number of packets involved in the collision using the preamble and/or the postamble of the first packet and the preamble and/or the postamble of the at least one other packet.

In one embodiment, the method is performed in a radio frequency identification (RFID) system; and the method further comprises transmitting a packet having both a preamble and a postamble to the remote node and estimating, at the remote node, a number of RFID tags located in a surrounding region using the preamble and/or the postamble of the transmitted packet.

In one embodiment, the method further comprises: transmitting a first packet having both a preamble and a postamble to the remote node, the first packet colliding with a second packet transmitted by another node; detecting the postamble of the first packet at the remote node; and using the detection of the postamble of the first packet at the remote node to infer a level of interference experienced with respect to the second packet.

In one embodiment, the method further comprises: transmitting a first packet having both a preamble and a postamble to the remote node, the first packet colliding with a second packet having both a preamble and a postamble; detecting the preamble of one of the first packet and the second packet at the remote node; using the detected preamble to estimate an end point of the one of the first packet and the second packet at the remote node; detecting the postamble of the other of the first packet and the second packet at the remote node; using the detected postamble to estimate a beginning point of the other of the first packet and the second packet at the remote node; and using the estimated beginning point of the other of the first packet and the second packet and the estimated end point of the one of the first packet and the second packet to analyze the collision.

In accordance with still another aspect of the concepts, systems, circuits, and techniques described herein, a method comprises: estimating a network parameter; and transmitting a packet with either a preamble and a postamble or just one of a preamble or a postamble based, at least in part, on the estimated network parameter.

In one embodiment, estimating a network parameter includes estimating a network traffic level.

In one embodiment, transmitting a packet includes transmitting a packet with a preamble and a postamble if the network traffic level is above a threshold value and transmitting a packet with a preamble but no postamble if the network traffic level is below a threshold value.

### BRIEF DESCRIPTION OF THE DRAWINGS

The foregoing features may be more fully understood from the following description of the drawings in which:

FIG. 1 is a block diagram illustrating a wireless communication network which may incorporate features described herein in one or more embodiments;

FIG. 2 is a signal timing diagram illustrating an example collision between two packets that may occur in a wireless network without postambles;

FIG. 3 is a signal timing diagram illustrating an example collision between two packets in a wireless network that uses both preambles and postambles in accordance with an embodiment;

FIG. 4 is a signal diagram illustrating long and short IEEE 802.11 preamble formats that may be used in accordance with an embodiment;

FIG. 5 is a signal diagram illustrating example postamble formats that may be used in accordance with an embodiment;

FIG. 6 is a signal timing diagram illustrating an example implementation of Zig-Zag decoding that may be modified in accordance with an embodiment; and

FIG. 7 is a block diagram illustrating an example node device architecture that may be used in a node device that incorporates features described herein in accordance with an embodiment.

### DETAILED DESCRIPTION

In order to alleviate issues associated with maintaining packet separation at receivers, some systems have proposed partial or full capture of overlapping packets. In such systems, the packet information that is available by examining packets from a single collision (which can involve two or more packets overlapping one another) at a receiver may be used to attempt to recover packets fully (in the case of full capture) or partially (in the case of partial capture). Full capture of both packets generally requires that relative signal strengths and noise levels be such that certain techniques, such as direct-sequence-spread-spectrum code-division multiplexing and multi-user detection, be applicable.

Partial capture schemes combine, in various ways, the reception of a collision with other receptions, such as those of one or more other collisions. New variants upon the theme of using the reception of multiple collisions to infer collided packets have been described in the literature. In some systems, for example, packets may be recovered from a sufficient number of transmissions from each source, where each collision can be considered as a linear combination of aligned packets (see, for example, (1) “Network-Assisted Diversity for Random Access Wireless Networks” by M. Tsatsanis, R. Zhang, S. Banerjee, IEEE Trans. Signal Processing, Vol. 48, no. 3, March 2000; (2) “Collision Resolution in Packet Radio Networks Using Rotational Invariance Techniques” by R. Zhang, N. Sidiropoulos, and M. Tsatsanis, IEEE Trans. Commun., Vol. 50, No. 1, Jan. 2002; and (3) “High-Throughput Random Access Using Successive Interference Cancellation in a Tree Algorithm” by Y. Yu and G. Giannakis, IEEE. Trans. Info. Theory, Vol. 53, No. 12, Dec. 2007.)

In a technique known as Zig-Zag decoding, the asynchrony of packet transmissions can be used so that colliding packets can be viewed as forming linear combinations with different offsets for different collision events that can be used to recover the originally transmitted packets (see, for example, “ZigZag Decoding: Combating Hidden Terminals in Wireless Networks” by S. Gollakota and D. Katabi, ACM SIGCOMM, 2008). For example, in one approach, portions of packets that did not experience collisions may be used to infer portions of other packets that collided with that portion of the first packet in another collision. Those inferred portions can then, in turn, be used to infer other portions of packets, until all packets have been recovered. This technique, and others like it, may assume a high signal-to-noise ratio at the receiver. Such techniques may also assume that the symbols of the packets are adequately recognized as such at the receivers.

In packet capture schemes, a mechanism for identifying or capturing packets and/or packet portions is typically needed. This identification function may be performed, for example, through the use of signals that enable synchronization during reception of specific symbols. In the absence of such signals, the identification of packets may be rendered difficult, if not impossible. The sequence of symbols that enable synchronization and/or identification of packets are generally placed at the beginning of the packet and may be termed “preambles.” In some systems where synchronization and identification of packets is particularly difficult, the preamble may be given a significant portion of the available symbols of a packet. Such a considerable overhead may be justified by the fact that, if the preamble's role of allowing capture of a packet, even in the absence of collision, is not fulfilled, the entire packet may be rendered useless at the receiver thereby requiring palliative measures, such as retransmissions, to be undertaken.

In various embodiments, communication systems, techniques, and/or devices are provided that may generate and use packets having both a preamble at the beginning of the packet and a postamble at the end of the packet. The preamble and the postamble may each include sequences and/or other information that allow the packets to be identified as packets for use in various applications. The use of a postamble in addition to a preamble may provide many benefits within a corresponding network or system. For example, a postamble may aid in the capture of a packet when a collision or other deleterious effects of the channel degrade a portion of the packet that includes the preamble (e.g., a leading portion of the packet). Such an approach may be useful, for example, in facilitating the use of partial capture techniques, such as Zig-Zag decoding.

In another potential benefit, the identification of the postamble of one packet may provide side information as to the interference level experienced by various parts of another packet, which may be useful in the decoding process. For example, the Interference level may be used as part of a multi-user detection (MUD) decoding process for the other packet. In yet another benefit, in some applications, a receiver may use both a preamble and a postamble of a packet to improve a probability of capture for the packet. Postambles may also be used to identify the ends of packets in situations where multiple-packet collisions occur. The identification of the beginning and end of a packet can aid in the interpretation of the information from collisions, thus facilitating capture. This beginning and end information may also be of assistance in estimating a number of packets (or a number of tags, in the case of RFID) that are involved in a collision.

In some networks and systems, preambles may also provide functions in addition to identification and/or synchronization, such as to convey information or to estimate a channel. In various embodiments, postambles within packets may be used to make these additional functions more robust. For example, if a channel varies over the duration of a packet, or if part or all of the preamble is corrupted, a postamble may be used to provide a more accurate channel estimation. This improved channel estimation may, in some instances, enable decoding to be achieved when the preamble alone would have precluded it. The improved channel estimation may also facilitate better rate selection.

The preamble/postamble approach may also have application in other types of systems. For example, in one application, packets having both preambles and postambles may be employed in RFID systems. For example, each message in these systems is typically sent with a preamble, and message collision is a potentially substantial obstacle. Use of a postamble, in addition to a preamble, could help resolve collisions in these systems. In addition, as described previously, the preamble/postamble technique could also aid in determining the number of RFID tags in an area.

In some implementations, postambles may only be added to packets in certain situations (e.g., in response to a predetermined condition). For example, postambles may be added in response to challenging network conditions in some embodiments. If a high level of congestion is observed in a network, for example, it may be assumed that more collisions are going to occur. A system or device may therefore begin to add postambles to transmit packets when network traffic levels exceed a particular threshold or fall within a particular range. In general, the use of postambles may allow a greater average number of packets to be detected and/or decoded per time slot in a network or system, thereby resulting in higher throughputs, shorter delays, and reduced feedback overhead.

In some embodiments, one or more sensors or estimators may be provided to obtain information about one or more network conditions or parameters. The sensor(s) or estimator(s) may, for example, measure or estimate values related to the one or more network conditions or parameters. Alternatively, or in addition, information about one or more network conditions or parameters may be received from a remote node (e.g., a destination node) via a feedback channel. Once obtained, the information may be used to determine whether or not to include both a preamble and a postamble in a transmitted packet or just one or the other.

In at least one embodiment, the techniques, devices, and systems described herein are used in densely packed wireless systems to facilitate packet capture in the network. For example, the techniques may be used within cellular systems that utilize femtocells or other small cells. The overlapping cellular regions that often result in systems that allow femtocell use can result in many interference and collision related problems. The techniques, devices, and systems described herein may also be used within networks that operate within the crowded 2.4 GHz band (which is used within, for example, WiFi, RFID, Bluetooth, and others) when, for example, multiple routers, access points, and/or user devices are located within communication range of one another. In such systems, the use of a postamble in addition to a preamble can enhance the ability of nodes to detect packets, even when collisions have occurred.

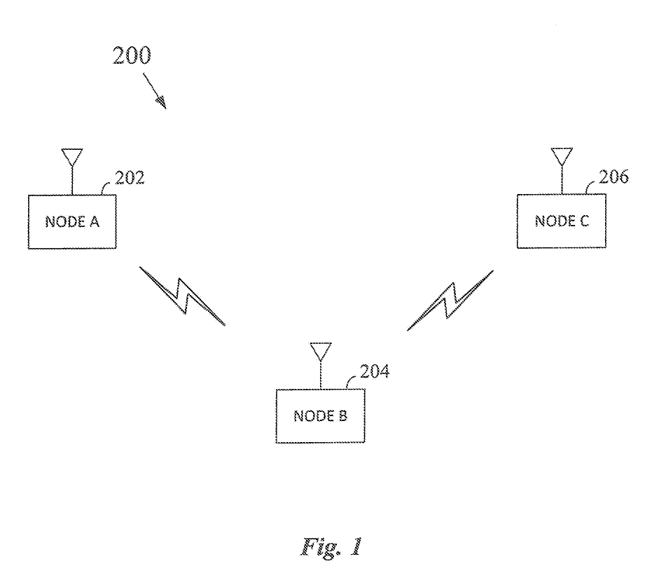

FIG. 1 is a block diagram illustrating a wireless communication network 200 that may incorporate features described herein in one or more embodiments. As illustrated, the wireless communication network 200 includes a first node 202, a second node 204, and a third node 206 that are each capable of communicating wirelessly with one another. In one operational scenario, the first node 202 and the third node 206 may each transmit a packet to the second node 204 at approximately the same time so that the packets overlap in time (or collide) at the receiver of the second node 204. In some systems, the second node 204 may just decide to ignore the collided packets. In some systems, however, the second node 204 may wish to decode either one or both of the collided packets. In some embodiments described herein, techniques are provided that increase the likelihood that some or all of the data within the collided packets can be recovered within the second node 204.

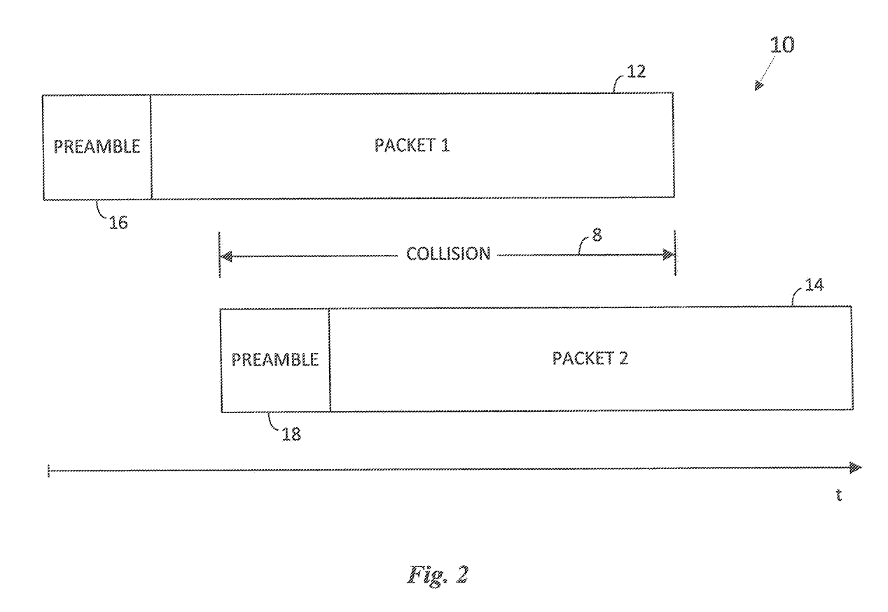

FIG. 2 is a signal timing diagram illustrating an example collision 10 between two packets that may occur in a wireless network. A first packet 12 that was transmitted by a first node may be received without postambles in the network at the same time that, or slightly before, a second packet 14 that was transmitted by a second node. Because the two packets 12, 14 overlap in time, a receiver node will often find it difficult or impossible to detect and decode one or both of the packets. Such a situation may occur, for example, as a result of the well known hidden node problem. As shown in FIG. 2, the first and second packets 12, 14 may each include a respective preamble 16, 18 that can be used by receiver nodes to, for example, detect the presence of the corresponding packet. In general, the preamble may include information (e.g., a particular data sequence or other information) that a receiver node can use to determine that a packet has been received, as well as additional information for use in decoding the packet. When a collision occurs, however, one or more of the corresponding preambles may be corrupted by interference with the other packet(s), rendering packet capture difficult or impossible. With reference to FIG. 2, for example, a receiver node would most likely be able to recognize the first packet 12 as having been received because the preamble 16 of the first packet 12 is outside of the overlapping collision area 8 between the packets 12, 14. The receiver node may find it difficult or impossible to recognize the second packet 14, however, because corresponding preamble 18 is part of the overlapping collision area 8.

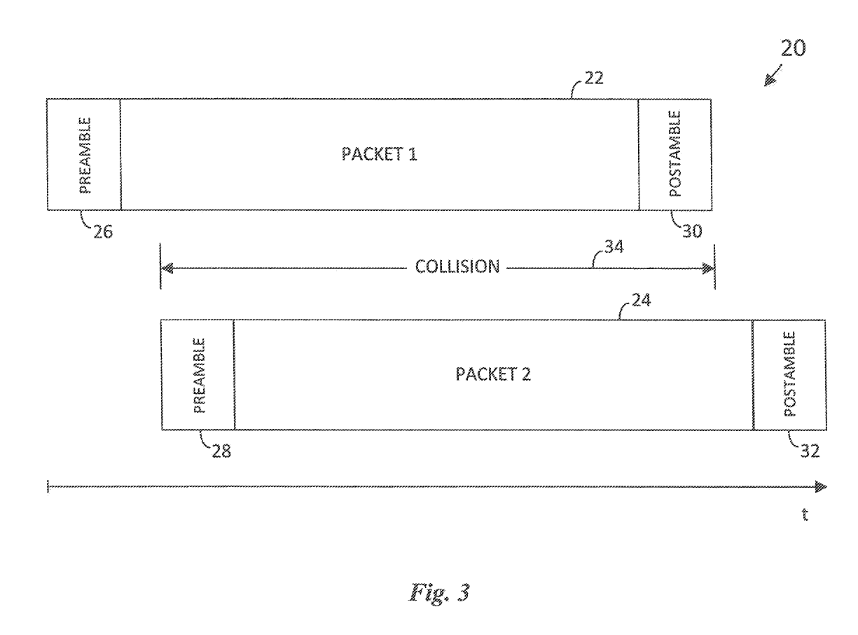

FIG. 3 is a signal timing diagram illustrating an example collision 20 between two packets in a wireless network in accordance with an embodiment that uses postambles. A first packet 22, which was transmitted by a first node may be received in the network at the same time that, or slightly before, a second packet 24, which is transmitted by a second node. As before, the first and second packets 22, 24 may each include a respective preamble 26, 28. In addition, the first and second packets 22, 24 may also each include a respective postamble 30, 32. Like the preambles 26, 28, the postambles 30, 32 may include information that may be used by a receiver node to detect the presence of or capture a received packet. In some implementations, for example, the same information may be present in the postambles 30, 32 that is present in the corresponding preambles 26, 28. In other implementations, as will be discussed in greater detail, some differences may exist in the content of preambles and postambles.

As Illustrated in FIG. 3, the preamble 26 of the first packet 22 is not part of the overlapping collision area 34 between the first and second packets 22, 24 and, therefore, may be used by a receiver node to capture the first packet 22 (or a portion thereof). The preamble 28 of the second packet 24, on the other hand, is part of the overlapping collision area 34 and may be corrupted. However, the postamble 32 of the second packet 24 is outside of the collision area 34 and, therefore, is available for use by a receiver node to detect the second packet 24. Like the preamble 28 of the second packet 24, the postamble 30 of the first packet 22 is part of collision area 34 and may be corrupted, but the first packet 22 will most likely be captured using the preamble 26 and, therefore, the postamble 30 may not be needed.

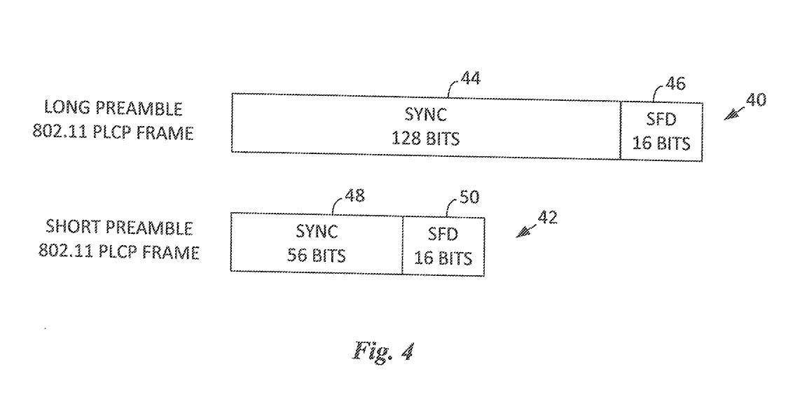

As described previously, in various implementations, preambles and postambles may include information that can be used by a receiver node to detect the presence of, or capture, a received packet, as well as to potentially aid in decoding the received packet. In at least one implementation, the content of preambles and postambles may both be based on the preamble format specified in the IEEE 802.11 wireless networking standard. In the IEEE 802.11 standard, for example, packets or frames may include a long or a short preamble that includes a synchronization (SYNC) field that may be used by receiver nodes to acquire the packet. The SYNC field may include a known sequence of bits that can be recognized by a receiver node by performing an auto-correlation operation. When the sequence is detected, the receiver node may assume that a packet has been received. FIG. 4 is a signal diagram illustrating the long and short IEEE 802.11 preamble formats that may be used in accordance with an implementation. As illustrated, the long preamble format 40 includes a 128 bit SYNC field 44 and a 16 bit start frame delimiter (SFD) field 46. Similarly, the short preamble format 42 includes a 56 bit SYNC field 48 and a 16 bit SFD field 50. The SFD fields 46, 50 of a frame or packet are used to identify the start of the frame data.

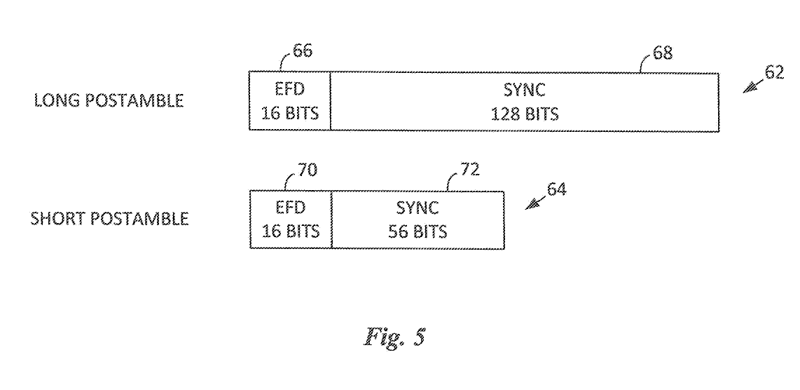

In some IEEE 802.11 based implementations, slight modifications may be made to the standard preamble formats for the postambles. FIG. 5 is a signal diagram illustrating example postamble formats that may be used in some implementations. As illustrated, a long postamble format 62 may include a 16-bit end frame delimiter (EFD) field 66 followed by a 128-bit SYNC field and a short postamble format 64 may include a 16-bit EFD field 70 followed by a 56-bit SYNC field 72. As described above, the SYNC fields 68, 72 may include known sequences of bits that can be recognized by a receiver node by performing an auto-correlation operation.

In some implementations, the preamble and postamble of a packet or frame may be made different from one another so that a receiver node is able to determine whether the captured packet is before or after the detected preamble/postamble. If the preamble formats of FIG. 4 and the postamble formats of FIG. 5 are used, for example, the location of the respective SFD and EFD fields may be used by a receiving node to determine whether a detected SYNC field is within a preamble or a postamble. Other techniques for distinguishing a preamble from a postamble may additionally or alternatively be used. For example, in one possible approach, a different SYNC sequence may be used in preambles and postambles. In another approach, an additional field including one or more toggle bits may be used to distinguish preambles from postambles (e.g., 01 after a SYNC field may indicate a preamble and 10 after a SYNC field may indicate a postamble, etc.).

In some embodiments, the preamble or the postamble of a packet, or both, may include additional information that the other does not have. The additional information may or may not be information that is useful for decoding the signal. For example, in one implementation, the postamble of a signal and not the preamble, may include data rate information, packet length information, or some other information that may be useful to decode the signal. In another approach, the postamble of a signal and not the preamble may include additional user data or other information that is not useful during the decoding process. In some implementations, some additional information within a preamble or postamble may be useful for decoding, while other additional information is not.

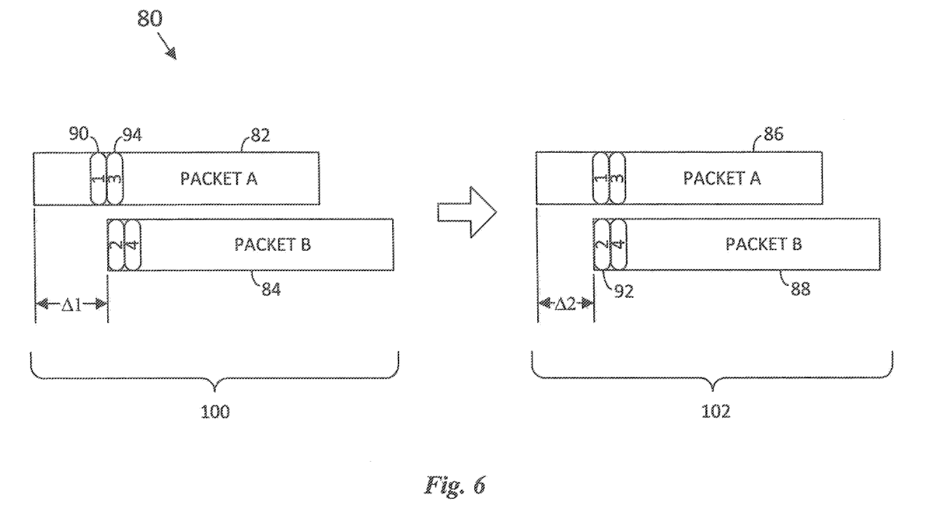

As described above, in various implementations, techniques described herein may be used to facilitate the performance of partial packet capture schemes for use in recovering from packet collision events. One technique that may benefit from this is Zig-Zag decoding. FIG. 6 is a signal timing diagram illustrating an example implementation 80 of Zig-Zag decoding that may be modified in accordance with an embodiment. As illustrated, first and second packets 82, 84 are transmitted by corresponding nodes at roughly the same time, causing a first collision 100 between the packets 82, 84. The offset between the first and second packets 82, 84 of first collision 100 is denoted in FIG. 6 as Δ1. A short period of time later, a retransmitted first packet 86 and a retransmitted second packet 88 are transmitted, resulting in a second collision 102. However, during the second collision 102, the offset between the packets changes to Δ2 (due to, for example, a randomized backoff process and/or other causes). When using Zig-Zag decoding, a receiving node may store past collision information for a period of time for use in future decoding operations.

In some instances, the Zig-Zag decoding process may start by identifying a portion, or chunk, of a received packet that is uncorrupted by collision during a first collision event and corrupted by collision during a second collision event. With reference to FIG. 6, for example, first chunk 90 fits this criterion. The receiver node can decode first chunk 90 using a standard process because it is uncorrupted. The receiver node may then subtract the decoded data of first chunk 90 from a corresponding portion of the second collision 102 to recover/decode data of second chunk 92 of retransmitted second packet 88. The decoded data of second chunk 92 of retransmitted second packet 88 may then be subtracted from a corresponding portion of first collision 100 to recover/decode data of third chunk 94 of first packet 82. This process may then be repeated until all of the first and second packets have been decoded.

In some implementations, postambles are included in packets/frames that are used in a system or network that utilizes Zig-Zag decoding. With reference to FIG. 6, by using postambles, more information may be available about second packet 84 and retransmitted second packet 88 that may allow the decoding process to be expedited. Most significantly, the postambles may facilitate the identification of second packet 84 and retransmitted second packet 88. The postambles may also allow a receiver node to more accurately determine a start point of second packet 84 and retransmitted second packet 88 within first collision 100 and second collision 102, respectively. The postambles may also permit a receiver node to initiate a Zig-Zag decoding process in a reverse direction, in addition to the process in the forward direction, to further expedite the decoding process. By operating from both ends of a collision, the time required to decode collided packets may be significantly reduced. In addition, performance of Zig-Zag decoding in both directions may also, or alternatively, improve the accuracy and reliability of the decoding process. As described previously, the preamble/postamble technique may also be used in connection with other partial capture schemes to facilitate the decoding of collided packets.

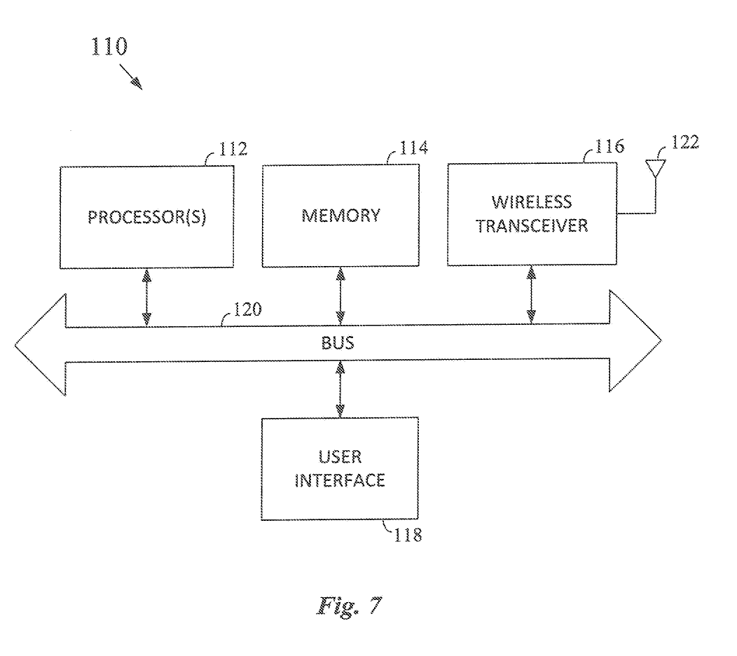

In various implementations, techniques described herein may be implemented within communication devices or nodes, radio frequency identification (RFID) tags and readers, or other types of devices that may be used within various communication systems or networks or other types of systems or networks, such as RFID systems. FIG. 7 is a block diagram illustrating an example node device architecture 110 that may be used in a node device that incorporates features described in the present disclosure in one or more implementations. As illustrated, the node device architecture 110 may include: one or more digital processors 112, a memory 114, a wireless transceiver 118, and a user interface 118. A bus 120 and/or other structure(s) may be provided for establishing interconnections between various components of device architecture 110. Digital processor(s) 112 may include one or more digital processing devices that are capable of executing programs or procedures to provide functions and/or services for a user. Memory 114 may include one or more digital data storage systems, devices, and/or components that may be used to store data and/or programs for other elements of node device architecture 110. User interface 118 may include any type of device, component, or subsystem for providing an interface between a user and a corresponding node device. Wireless transceiver 116 may include any type of transceiver that is capable of supporting wireless communication with one or more remote wireless entities.

Digital processor(s) 112 may include, for example, one or more general purpose microprocessors, digital signals processors (DSPs), controllers, microcontrollers, application specific integrated circuits (ASICs), field programmable gate arrays (FPGAs), programmable logic arrays (PLAs), programmable logic devices (PLDs), reduced instruction set computers (RISCs), and/or other processing devices or systems, including combinations of the above. Digital processor(s) 112 may be used to, for example, execute an operating system for a corresponding node device. Digital processor(s) 112 may also be used to, for example, execute one or more application programs for a node device. In addition, digital processor(s) 112 may be used to implement, either partially or fully, one or more of the communications related processes or techniques described herein in some implementations. For example, in at least one embodiment, digital processor(s) 112 may act as a packet generator within a node device to generate packets to be transmitted by wireless transceiver 116.

As described above, wireless transceiver 116 may include any type of transceiver that is capable of supporting wireless communication with one or more remote wireless entities. In various implementations, wireless transceiver 116 may be configured in accordance with one or more wireless networking standards and/or wireless cellular standards. In some implementations, multiple wireless transceivers may be provided to support operation in different networks or systems in a surrounding environment or with different wireless networking and/or cellular standards. Wireless transceiver 116 may, in some implementations, be capable of communicating with peer devices in a peer-to-peer, ad-hoc, or wireless mesh network arrangement. In addition, in some implementations, wireless transceiver 116 may be capable of communicating with a base station or access point or satellite of an infrastructure-type wireless communication system or network. Wireless transceiver 116 may include, in other implementations, a transponder for use in an RFID system.

As illustrated in FIG. 7, wireless transceiver 116 may be coupled to one or more antennas 122 and/or other transducers, to facilitate the transmission and/or reception of communication signals. In some implementations, wireless transceiver 116 may be used to implement, either partially or fully, one or more of the communications related processes or techniques described herein. It should be appreciated that the techniques described in the present disclosure may, in some implementations, be implemented in wired communications networks or other networks or systems that do not use wireless communication. In some of these implementations, wireless transceiver 116 may be replaced with or supplemented by, for example, a wired communication device, component, card, or other structure.

Memory 114 may include any type of system, device, or component, or combination thereof, that is capable of storing digital information (e.g., digital data, computer executable instructions and/or programs, etc.) for access by a processing device or other component. This may include, for example, semiconductor memories, magnetic data storage devices, disc based storage devices, optical storage devices, read only memories (ROMs), random access memories (RAMs), non-volatile memories, flash memories, USB drives, compact disc read only memories (CD-ROMs), DVDs, Blu-Ray disks, magneto-optical disks, erasable programmable ROMs (EPROMs), electrically erasable programmable ROMs (EEPROMs), magnetic or optical cards, and/or other digital storage suitable for storing electronic instructions and/or data. It should be appreciated that the node device architecture 110 of FIG. 7 represents one possible example of an architecture that may be used in an implementation. Other architectures may alternatively be used. As used herein, the term “node device” or “node” is used to describe any type of digital electronic device that includes some form of communication capability (wireless and/or wired).

The techniques and structures described herein may be implemented in any of a variety of different forms. For example, features of the invention may be embodied within various forms of communication devices, both wired and wireless; television sets; set top boxes; audio/video devices; laptop, palmtop, desktop, and tablet computers with or without wireless capability; personal digital assistants (PDAs); telephones; smart phones, RFID tags and readers; pagers; satellite communicators; cameras having communication capability; network interface cards (NICs) and other network interface structures; base stations; wireless access points; integrated circuits; as instructions and/or data structures stored on non-transitory computer readable media; and/or in other formats. Examples of different types of computer readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. An apparatus comprising:
means for obtaining information about a network parameter; and
a packet generator to generate a packet for transmission to a remote node, the packet generator to generate a packet having both a preamble and a postamble if the network parameter meets a predetermined criterion and a packet having only a preamble or a postamble if the network parameter does not meet the predetermined criterion.

2. The apparatus of claim 1, wherein:
the network parameter is a network traffic level and the predetermined criterion is the network traffic level exceeding a threshold level.

3. The apparatus of claim 1, wherein:
the preamble and the postamble of the packet generated by the packet generator if the network parameter meets the predetermined criterion both include information for use by a receiver in receipt of the packet to identify that a packet has arrived.

4. The apparatus of claim 1, wherein:
the postamble of the packet generated by the packet generator if the network parameter meets the predetermined criterion includes some information that the preamble does not include.

5. The apparatus of claim 1, wherein:
the preamble of the packet generated by the packet generator if the network parameter meets the predetermined criterion includes some information that the postamble does not include.

6. The apparatus of claim 1, wherein:
the postamble of the packet generated by the packet generator if the network parameter meets the predetermined criterion includes a field for at least one of packet length and packet data rate and the preamble of the packet does not.

7. The apparatus of claim 1, wherein:
the postamble of the packet generated by the packet generator if the network parameter meets the predetermined criterion includes a field for user data and the preamble of the packet does not.

8. The apparatus of claim 1, wherein:
the preamble and the postamble of the packet generated by the packet generator if the network parameter meets the predetermined criterion are identical.

9. The apparatus of claim 1, wherein:
the preamble and the postamble of the packet generated by the packet generator if the network parameter meets the predetermined criterion both include a SYNC field with a SYNC sequence for use by the remote node to synchronize with the packet upon reception.

10. The apparatus of claim 9, wherein:
the SYNC sequence in the preamble of the packet is different from the SYNC sequence in the postamble of the packet.

11. The apparatus of claim 9, wherein:
the SYNC sequence in both the preamble and the postamble of the packet are in accordance with those specified in the IEEE 802.11 family of wireless networking standards for use in a packet preamble.

12. The apparatus of claim 1, wherein:
the apparatus includes a wireless node device for use in a wireless network.

13. The apparatus of claim 1, wherein:
the apparatus includes a cellular telephone.

14. The apparatus of claim 1, wherein:
the apparatus includes an integrated circuit.

15. A method comprising:
determining whether one or more conditions exist in a network; and
generating a packet for transmission to a remote node in the network, wherein generating a packet includes generating a packet having both a preamble and a postamble if a predetermined condition exists in the network and generating a packet having only a preamble or a postamble if the predetermined condition does not exist in the network.

16. The method of claim 15, wherein:
generating a packet having both a preamble and a postamble includes generating a packet wherein the postamble includes some information that the preamble does not.

17. The method of claim 15, wherein:
generating a packet having both a preamble and a postamble includes generating a packet wherein the preamble includes some information that the postamble does not.

18. The method of claim 15, wherein:
generating a packet having both a preamble and a postamble includes generating a packet wherein the postamble includes a field for at least one of packet length and data rate of the packet and the preamble does not.

19. The method of claim 15, wherein:
generating a packet having both a preamble and a postamble includes generating a packet wherein the postamble includes a field for user data and the preamble portion does not.

20. The method of claim 15, wherein:
generating a packet having both a preamble and a postamble includes generating a packet wherein the preamble and the postamble are identical.

21. The method of claim 15, wherein:
generating a packet having both a preamble and a postamble includes generating a packet wherein both the preamble and the postamble of the packet include information intended for use by a receiver device in receipt of the packet to identify a beginning and an end of the packet.

22. The method of claim 15, wherein:
generating a packet includes generating a packet having both a preamble and a postamble if an estimated network traffic level is within a first range and transmitting a packet having a preamble portion but no postamble portion if the estimated network traffic level is not within the first range.

23. The method of claim 15, wherein:
generating a packet having both a preamble and a postamble includes generating a packet wherein the preamble and the postamble each include a SYNC field with a SYNC sequence for use by a receiver device to synchronize with the packet, wherein the SYNC sequence in the preamble is different from the SYNC sequence in the postamble.

24. The method of claim 15, further comprising:
transmitting a first packet having both a preamble and a postamble to the remote node, the first packet colliding with a second packet transmitted by another node; and
performing zig-zag decoding at the remote node to recover data within both the first packet and the second packet, wherein performing zig-zag decoding includes using a postamble associated with either the first packet or the second packet to determine a starting point of the packet.

25. The method of claim 24, wherein:
performing zig-zag decoding includes performing zig-zag decoding in both a forward direction and a reverse direction, wherein performing zig-zag decoding in a reverse direction includes using a postamble associated with either the first packet or the second packet.

26. The method of claim 15, further comprising:
transmitting a first packet having both a preamble and a postamble to the remote node, the first packet colliding with at least one other packet transmitted by at least one other node; and
estimating, at the remote node, a number of packets involved in the collision using the preamble and/or the postamble of the first packet and the preamble and/or the postamble of the at least one other packet.

27. The method of claim 15, wherein:
the method is performed in a radio frequency identification (RFID) system; and
the method further comprises transmitting a packet having both a preamble and a postamble to the remote node and estimating, at the remote node, a number of RFID tags located in a surrounding region using the preamble and/or the postamble of the transmitted packet.

28. The method of claim 15, further comprising:
transmitting a first packet having both a preamble and a postamble to the remote node, the first packet colliding with a second packet transmitted by another node;
detecting the postamble of the first packet at the remote node; and
using the detection of the postamble of the first packet at the remote node to infer a level of interference experienced with respect to the second packet.

29. The method of claim 15, further comprising:
transmitting a first packet having both a preamble and a postamble to the remote node, the first packet colliding with a second packet having both a preamble and a postamble;
detecting the preamble of one of the first packet and the second packet at the remote node;
using the detected preamble to estimate an end point of the one of the first packet and the second packet at the remote node;
detecting the postamble of the other of the first packet and the second packet at the remote node;
using the detected postamble to estimate a beginning point of the other of the first packet and the second packet at the remote node; and
using the estimated beginning point and the estimated end point to analyze the collision.

30. A method comprising:
estimating a network parameter; and
transmitting a packet with either a preamble and a postamble or just one of a preamble or a postamble based, at least in part, on the estimated network parameter.

31. The method of claim 30, wherein:
estimating a network parameter includes estimating a network traffic level.

32. The method of claim 30, wherein:
transmitting a packet includes transmitting a packet with a preamble and a postamble if the network traffic level is above a threshold value and transmitting a packet with a preamble but no postamble if the network traffic level is below a threshold value.
